(19) United States
(12) Patent Application Publication
(10) Pub. No.: US 2005/0209774 A1
(43) Pub. Date: Sep. 22, 2005

(54) Digital map system

(75) Inventor: Doug Finlay, Emerald Hills, CA (US)

Correspondence Address: VAN PELT, YI & JAMES LLP, 10050 N. FOOTHILL BLVD #200, CUPERTINO, CA, 95014, US

(73) Assignee: SpeedInfo

(21) Appl. No.: 10/807,461

(22) Filed: Mar. 22, 2004

(51) Int. Cl. G01C 21/26

(52) U.S. Cl. 701/208; 701/200

(57) ABSTRACT

A method of broadcasting a digital traffic map is disclosed. The method comprises transmitting to a plurality of receivers a first road segment having a first segment first endpoint and a first segment second endpoint, and transmitting to a plurality of receivers a second road segment having a second segment first endpoint and a second segment second endpoint. The first segment and the second segment are combined together to form a portion of the digital map.

### FIELD OF THE INVENTION

The present invention relates generally to digital maps. More specifically, a system for transmitting and receiving a digital map is disclosed.

### BACKGROUND OF THE INVENTION

Maps are frequently used for helping a driver to navigate from one point to another or to navigate a route to a number of points. More specifically, there are both web based maps (e.g., www.maps.yahoo.com) and static digital maps in vehicle navigation systems.

Web-based maps use a digital map server to generate a static picture that is broadcast over the web. Services like Yahoo Maps and MapQuest do not transmit the digital map itself; they broadcast a picture (usually a .jpg file) to the user.

Navigation systems do not transmit maps at all. They store maps in a static database on one or more removable disks. Some will receive incident information, in the form of a notice that is geocoded to a specific latitude and longitude. The user sees a flashing icon on the map that indicates some type of problem (like a road closure or accident).

However, digital maps, in general, are not transmitted or broadcast due to their size. They can be more accurately described as databases with millions of objects that all have a corresponding latitude and longitude, and whose location can be plotted on the earth. But, digital maps are not useful without the appropriate mapping software to plot the data.

This present invention describes how to transmit and receive a simplified digital map, and update this map to reflect real-time conditions.

### BRIEF DESCRIPTION OF THE DRAWINGS

Various embodiments of the invention are disclosed in the following detailed description and the accompanying drawings.

FIG. 1 is a block diagram illustrating a system for transmitting and receiving a digital map.

FIG. 2 is a flow chart illustrating the steps in processing speed data from a sensor.

FIG. 3 is a flow chart illustrating the steps for processing speed data from a public database.

FIG. 4 is a flow chart illustrating the steps for transmission scheduling.

FIG. 5 illustrates a transmit schedule of data and format for a detailed road segment, a speed update, and a translation packet.

FIG. 6 is a flow chart illustrating a processing sequence for the data received by the receiver.

FIG. 7 is a diagram illustrating database structures that the receiver uses.

FIG. 8 is a digital map display.

FIG. 9 is a flow chart illustrating a process for displaying a digital map.

FIG. 10 is a flow chart illustrating a process for updating an optimum trip plan.

FIG. 11 is a flow chart illustrating a process for updating an optimum route plan.

FIG. 12 is a flow chart illustrating a process for a receiver choosing a best signal.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and invention may be practiced according to the claims without some or all of these specific details. For the purpose of clarity, technical material that is known in the technical fields related to the invention has not been described in detail so that the invention is not unnecessarily obscured.

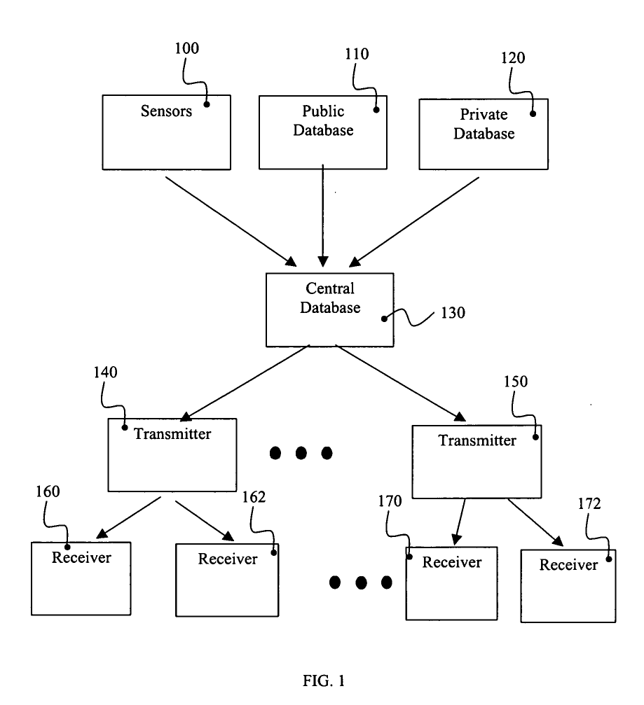

FIG. 1 is a block diagram illustrating a system for transmitting and receiving a digital map. Data from sources such as sensors 100, public databases 110, and private databases 120 are fed into the central database 130. The data from these sources is processed and then sent to one or more transmitters. Central database 130 processes the information from the sensors 100 and databases 110 and 120, schedules the data to be transmitted, and sends information to transmitter 140 and transmitter 150. The signals are received by one or more receivers. The signal from transmitter 140 is received by receiver 160 and receiver 162 and the signal from transmitter 150 is received by receiver 170 and receiver 172.

In one embodiment, Data from sensors 100 may include information about the number of vehicles passing a sensor or the average speed of the vehicles passing a sensor. Data from sensors 100 may also include information about the weather such as how much fog is near the sensor. Data from sensors 100 may also include other local conditions, like temperature of the road surface. In one embodiment, data from public databases 110 is information about the speed of vehicles on road segments, the number of vehicles on road segments, accident information, weather information, or driver alert information (e.g. amber alerts about the abduction of children). In one embodiment, data from private databases 120 is information about the location of road segments, lengths of road segments, or locations of points of interest. In another embodiment, data from private databases 120 is information about the speed of vehicles on road segments, the number of vehicles on road segments, accident information, or weather information. Although data from sensors 100, public databases 110, and private databases 120 can be many different types of data, speed data will be used for the purpose of example in the following description.

Before the digital map data can be processed, it must be simplified. Digital maps of major US cities consist of millions of road segments, points of interest, topographical or geographical features, and locations of railroads, airports, bridges, and parks. This data cannot be transmitted in its native form because the files are so large. Instead, line features and polygons on the map need to be simplified, sometimes with 50 or more road segments being consolidated into one. When polygons are used to represent features such as parks or lakes, their borders need to be simplified to retain their basic shape, even though some detail is lost. Some roads, points of interest, and other features are eliminated in their entirety.

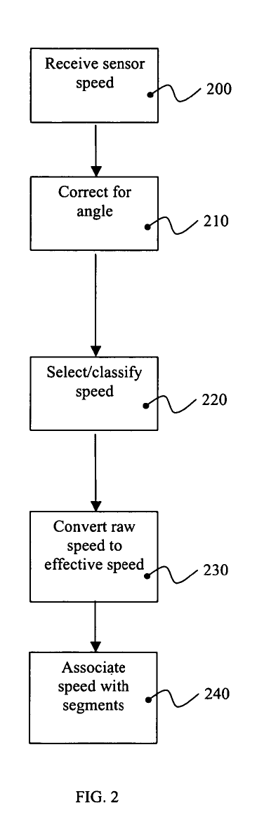

FIG. 2 is a flow chart illustrating the steps in processing speed data from a sensor. Speed data from sensors 100, public databases 110, and private databases 120 are fed into the central database 130 where it is processed. In step 200, the sensor speed is received. In some embodiments, the sensor speed is received in real-time such that the information is a reflection of the speed that a driver would experience on a road segment. The sensor is mounted such that the traffic moves toward or away from the sensor at some angle. So, in step 210, the speed data is corrected for this mounting angle. The sensor speed data can contain two speeds when the road segment has a high occupancy vehicle (HOV) lane. In step 220, the speed data is classified as HOV or non-HOV speed data. In step 230, the speed data is further processed by converting the raw speed to an effective speed. For a road segment with traffic lights, stop signs, or merging traffic the raw speed data does not translate directly to the time it takes to travel the length of the road segment. In some embodiments, the effective speed conversion uses measurements of a vehicle traveling a given road segment to correlate raw speed to effective speed over the length of that particular road segment. In some embodiments, this translation between raw speed and effective speed is dependent on the time of the day or the day of the week. In step 240, the effective speed is associated with the road segment in the central database. The effective speed is one variable that may be included in a set of variables that comprise the state of the segment. The segment state may also include incident information (e.g. accident), road condition information, construction information, weather information, and warnings about hazardous conditions like a toxic gas leak or a flood.

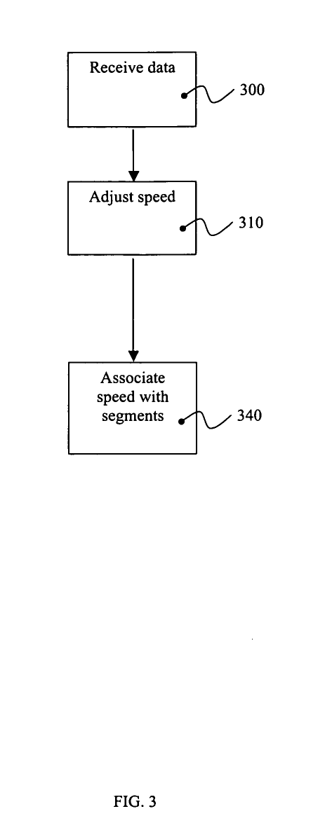

FIG. 3 is a flow chart illustrating the steps for processing speed data from a public database. In step 300 of this embodiment, traffic speed data is received. In step 310, the speed data is adjusted to an effective speed based on information about the reliability and accuracy of the speed data from a given location. In some embodiments, the speed information at a given location might be known to be 10% higher than the actual speed. In some embodiments, the speed information at a given location might be known to be unreliable. In step 340, the effective speed is associated with the road segment in the central database. In some embodiments, processing of private database speed information is similar to processing public database speed information processing.

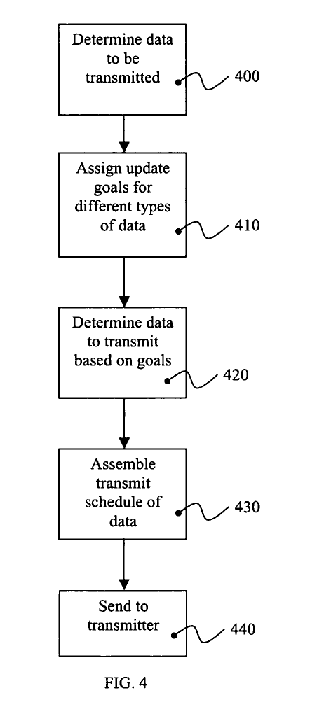

FIG. 4 is a flow chart illustrating the steps for transmission scheduling. After the speed information has been processed, it is made ready for transmission. In step 400, data is chosen for transmission. In one embodiment, the data includes map system elements such as detailed road segment data packets, speed update information packets, and translator packets. In some embodiments, the data further includes map system elements such as an area of interest, points of interest, incident information (i.e. traffic accidents) and the location associated with them, messages, advertisements, or a list of radio stations in the area carrying a data stream. In some embodiments, an area of interest is described using a polygon, which includes a series of lines (each of which have a first endpoint and a second endpoint) that when linked together enclose the area of interest. In step 410, data is assigned a priority for transmission to the receiver. In one embodiment, speed updates, where speeds for a given road segment are slow, are transmitted most frequently (for example, every 15 seconds), speed updates where speeds for a given road segment are fast are transmitted less frequently (for example, every minute), and detailed road segments and translator packets are transmitted infrequently (for example, every 15 minutes). The frequency of transmission is based on its importance and the bandwidth of the wireless connection. In step 420, data is selected for transmission based on the priorities goals set.

In step 430, a transmit schedule of data is assembled. In step 440, the assembled data is sent to a transmitter. In some embodiments, there can be a plurality of transmitters. For each transmitter, a plurality of receivers may be found in a plurality of vehicles. The receiver might be a display like a PDA, a head-up display in the car, or an in-car DVD player. In other embodiments, the digital map is transmitted to other applications (like a route optimization server) or other platforms (like a color cell phone or a kiosk at a shopping center).

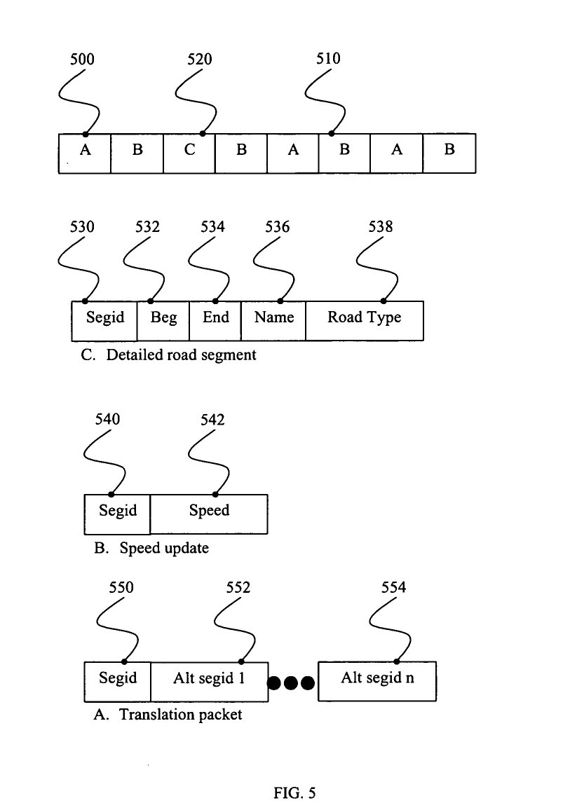

FIG. 5 illustrates a transmit schedule of data and format for a detailed road segment, a speed update, and a translation packet. In one embodiment, the transmit schedule of data has packets of information in the sequence A (500), B, C (510), B, A, B (520), A, B, where A is a detailed road segment packet, B is a speed update packet, and C is a translation packet. The detailed road segment packet contains a road segment identifier (Segid 530), a road segment first endpoint latitude and longitude (Beg 532), a road segment second endpoint latitude and longitude (End 534), a name (Name 536), and a road type (road type 538). For example, the road type may be a high occupancy vehicle road. A portion of a digital map is formed by combining together a first road segment having a first segment first endpoint and a first segment second endpoint and a second road segment having a second segment first endpoint and a second segment second endpoint. The speed update information packet contains a road segment identifier (Segid 540) and a speed (Speed 542). The translator packet contains a road segment identifier (Segid 550) and n alternate road segment identifiers (Alt segid 1 to Alt segid n 552 to 554), where n is an integer. The translator packets allow the receiver to correspond road segment identifiers in one database to road segment identifiers in another database. In some embodiments, the road segment identifiers are part of a digital map system and the alternate road segment identifiers are part of a navigation system database. In some embodiments, the navigation system database has optimum trip planning and optimum route planning capabilities.

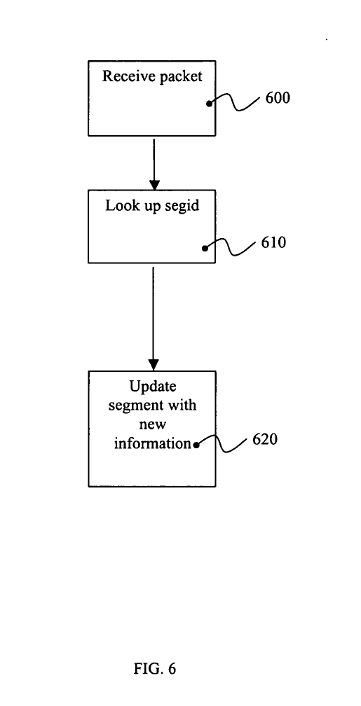

FIG. 6 is a flow chart illustrating a processing sequence for the data received by the receiver. In step 600, a packet is received by the receiver. In step 610, the segment identifier is used to look up a corresponding database entry in the receiver database. In step 620, the receiver then updates the corresponding database entry in the receiver database.

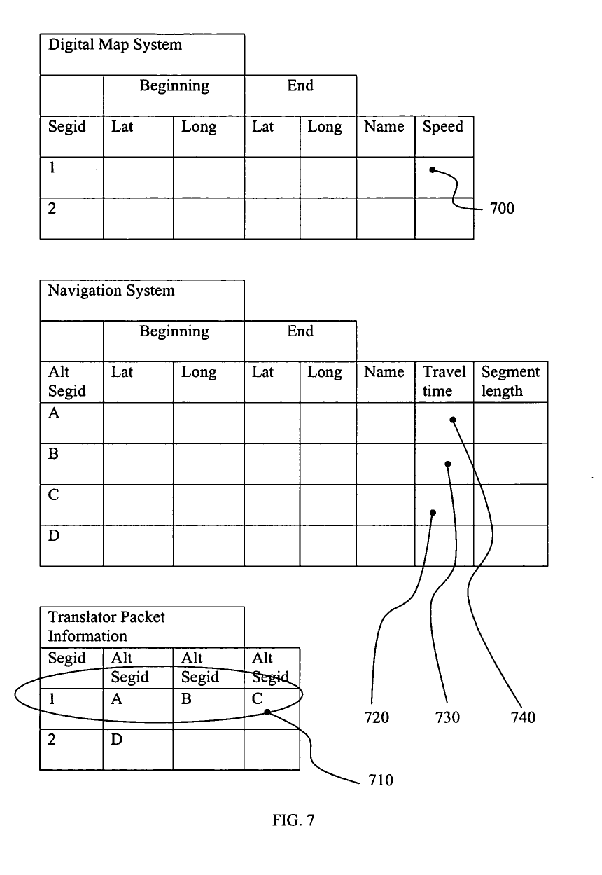

FIG. 7 is a diagram illustrating database structures that the receiver uses. The road segment identifier is used along with the information in the translator packet to look up the corresponding database entry according to the alternate road segment identifiers in the alternate database. The receiver receives speed information 700 associated with a Segid 1 of the digital map system. The receiver also receives translator packet information 710 which identifies that Segid 1 is associated with Alt Segid's A, B, and C. The speed information 700 is then used along with the segment length information for Alt Segid's A, B, and C to calculate the travel time entries 720, 730, and 740. When the speed information is updated, the travel time entries are updated again.

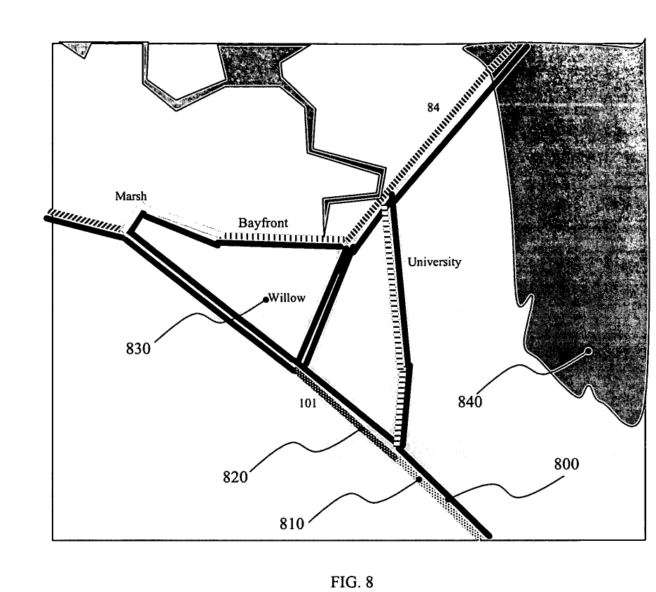

FIG. 8 is a digital map display. The receiver receives speed information associated with road segments which are identified by Segid's. The speed information is used to change the display to indicate the speed vehicles are traveling at on a given road segment. Different shadings (800, 810, and 820) or colors are used to indicate the speed of travel in the different travel directions. The digital map also displays road segment names 830 (Willow road) and points of interest 840 (outline of a bay). In some embodiments, there is a user setting that determines if the road segment speeds are displayed using a table of different colors, an alternate table of different colors, a table of different shades of gray, or a table of different patterns corresponding to each speed.

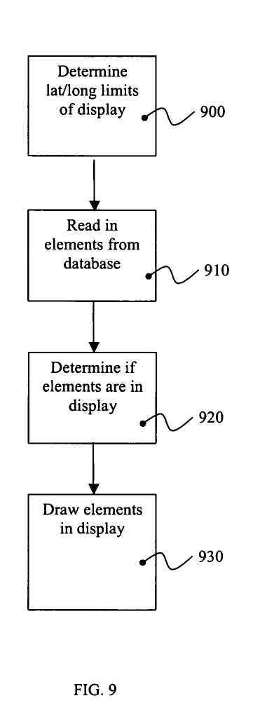

FIG. 9 is a flow chart illustrating a process for displaying a digital map. The first step is to determine the latitude/longitude limits of the display 900. The limits of the display are usually of an area near to the receiver location. In some embodiments, a user selects the limits of the display by panning left/right and up/down and also by selecting a zoom or magnification setting for the display. The next step is to read in the elements from the database 910. In some embodiments, the elements may include road segments, polygons representing areas or features in the digital map (e.g., parks, lakes, bays, rivers, etc.), points of interest, weather, or traffic incidents. The next step is to determine if the element is in the display limits 920. In some embodiments, this is accomplished by ascertaining if the element, or part of the element, lies within the latitude/longitude limits of the display. The last step is to draw the element on the display 930. In some embodiments, a road segment is displayed with a color or a pattern determined by the speed of traffic on that road segment. In other embodiments, the color or pattern is determined by the difference in speed of traffic on that road segment from the typical speed of traffic on that road segment at that time of day.

The level of map detail in the display depends on how much area is displayed and/or the level of detail the user has selected. For example, the description of an accident may only be displayed if the display was zoomed in where the accident was located. And, as another example, when the display is zoomed out to display an area with multiple cities (e.g. the San Francisco Bay Area), the display would only show major traffic arteries like interstate highways and landmarks like large bodies of water.

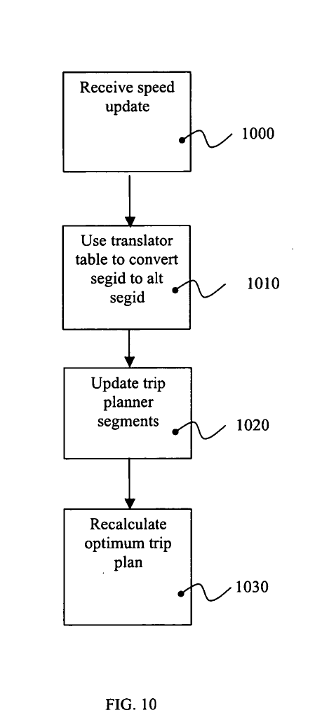

FIG. 10 is a flow chart illustrating a process for updating an optimum trip plan, where “optimum” represents the trip which takes the shortest amount of time based on current road conditions. The speed information for road segments can be used to update an optimum trip plan. The first step is receiving a speed update 1000. The next step is to use the translator packet to convert the speed information associated with the segids to speed information associated with the alt segids 1010.

The trip optimization software knows the length of each of the road segments in its database. It can recalculate how long it will take to travel on each of the affected road segments, based on the new speed information. Next, it can recalculate the optimum route, based on the newly revised travel times. These updated segments are then transferred to the trip planner calculator 1020. The trip planner calculator then recalculates the optimum trip plan based on the updated speed information 1030.

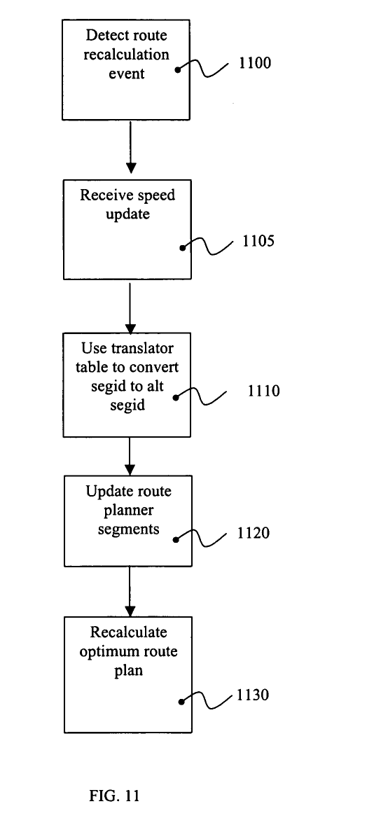

FIG. 11 is a flow chart illustrating a process for updating an optimum multi-destination route plan. The speed information for road segments can be used to update an optimum route plan. The first step is to detect a route recalculation event 1100. The route recalculation event may be the arrival at an intermediate destination, a traffic event along the current optimum route, a user request for recalculation, an addition or deletion of stops along the route, or a weather event. The next step is receiving a speed update 1105. The next step is to use the translator packet to convert the speed information associated with the segids to speed information associated with the alt segids 1110. These updated segments are then transferred to the route planner calculator 1120. The route planner calculator then recalculates the optimum route plan based on the updated speed information 1130.

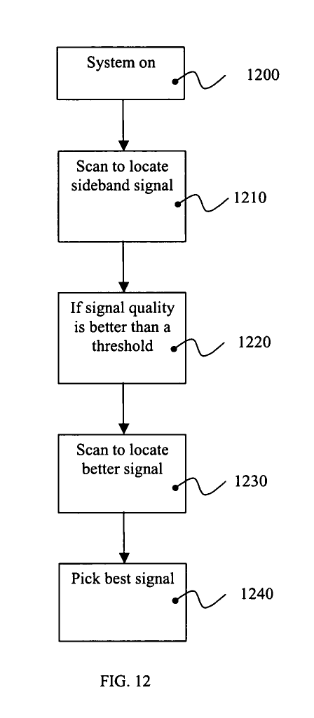

FIG. 12 is a flow chart illustrating a process for a receiver choosing a best signal. The first step in the flow diagram is the system turning on 1200. The system scans to locate the proper signal 1210. In some embodiments, the signal is a FM sideband signal which may be located in the unused 100 KHz portion allocated to FM broadcasters. If a list of known frequencies is available, the system may scan the list of known frequencies first. If the signal quality is better than a threshold, the signal can be used by the receiver 1220.

Any appropriate measure of signal quality may be used. For example, average signal strength, minimum signal strength, or SNR are used in various embodiments. The signal quality may also be measured using the Bit Error Rate (BER), and the threshold may be a maximum BER. The next step is to scan for a better signal 1230. After a number of signals have been identified, the best signal is chosen 1240. In some embodiments, the lowest BER may not be associated with the strongest signal.

Although the foregoing embodiments have been described in some detail for purposes of clarity of understanding, the invention is not limited to the details provided. There are many alternative ways of implementing the invention. The disclosed embodiments are illustrative and not restrictive.

1. A method of broadcasting a digital traffic map comprising:
transmitting to a plurality of receivers a first road segment having a first segment first endpoint and a first segment second endpoint, and
transmitting to a plurality of receivers a second road segment having a second segment first endpoint and a second segment second endpoint wherein the first segment and the second segment are combined together to form a portion of the digital map.

2. A method of broadcasting a digital traffic map as in claim 1 wherein the first segment has a segment state.

3. A method of broadcasting a digital traffic map as in claim 1 wherein the first segment has a segment state that varies over time.

4. A method of broadcasting a digital traffic map as in claim 1 wherein the first segment has a segment state including speed information.

5. A method of broadcasting a digital traffic map as in claim 1 wherein the first segment has a segment state including weather information.

6. A method of broadcasting a digital traffic map as in claim 1 wherein the first segment has a segment state including accident information.

7. A method of broadcasting a digital traffic map as in claim 1 wherein the first segment is part of a polygon that enclose an area of interest.

8. A method of broadcasting a digital traffic map as in claim 1 wherein the first segment has a segment state including road condition information.

9. A method of broadcasting a digital traffic map as in claim 1 wherein the first segment has a segment state and a transmitter transmits an updated segment state based on a real-time measurement.

10. A method of broadcasting a digital traffic map as in claim 1 wherein the first segment has a segment state and the source of information for the segment state is a sensor.

11. A method of broadcasting a digital traffic map as in claim 1 wherein the first segment has a segment state and the source of information for the segment state is a private database.

12. A method of broadcasting a digital traffic map as in claim 1 wherein the first segment has a segment state and the source of information for the segment state is a public database.

13. A method of broadcasting a digital traffic map as in claim 1 wherein the first segment has a segment state and the segment state is derived by processing information from a sensor.

14. A method of broadcasting a digital traffic map as in claim 1 wherein the first segment has a segment state and the segment state is derived by processing information from a private database.

15. A method of broadcasting a digital traffic map as in claim 1 wherein the first segment has a segment state and the segment state is derived by processing information from a public database.

16. A method of broadcasting a digital traffic map as in claim 1 wherein the first segment has a segment state and the segment state is derived by correcting speed data for a mounting angle of a sensor.

17. A method of broadcasting a digital traffic map as in claim 1 wherein the first segment has a segment state and the segment state is derived by converting a raw speed to an effective speed.

18. A method of broadcasting a digital traffic map as in claim 1 wherein the first segment has a segment state and the segment state is derived by converting a raw speed to an effective speed using measurements of a vehicle traveling a given road segment.

19. A method of broadcasting a digital traffic map as in claim 1 wherein the road segment endpoints are transmitted in a road segment data packet.

20. A method of broadcasting a digital traffic map as in claim 1 wherein the road segment endpoints are transmitted in a road segment data packet that is comprised of a segment identifier, a first endpoint longitude and latitude, and a second endpoint longitude and latitude.

21. A method of broadcasting a digital traffic map as in claim 1 wherein the road segment endpoints are transmitted in a road segment data packet that is comprised of a segment identifier, a first endpoint longitude and latitude, a second endpoint longitude and latitude, a name, and a road type.

22. A method of broadcasting a digital traffic map as in claim 1 wherein the first segment has a segment speed state and the segment speed state is transmitted in a speed update information packet.

23. A method of broadcasting a digital traffic map as in claim 1 wherein the first segment has a segment speed state and the segment speed state is transmitted in a speed update information packet that is comprised of a segment identifier and a speed.

24. A method of broadcasting a digital traffic map as in claim 1 wherein the first segment has a segment state and a transmitter transmits an updated segment state that is used to update a database.

25. A method of broadcasting a digital traffic map as in claim 1 wherein the first segment has a segment state and the segment state is used to update an optimum trip plan.

26. A method of broadcasting a digital traffic map as in claim 1 wherein the first segment has a segment state and the segment state is used to update an optimum route plan.

27. A method of broadcasting a digital traffic map as in claim 1 wherein the first segment has a segment state and the segment state is used to update a digital map display.

28. A method of broadcasting a digital traffic map as in claim 1 wherein the first segment has a segment state and the segment state is used to update a digital map display whose displayed level of detail depends on the size of the area displayed in the display.

29. A method of broadcasting a digital traffic map as in claim 1 wherein the first segment has a segment state and the segment state is used to update a digital map display whose displayed level of detail depends on a user selection.

30. A method of broadcasting a digital traffic map as in claim 1 wherein the first segment has a segment state and the segment state is used to update a digital map display of the area near to the receiver location.

31. A method of broadcasting a digital traffic map as in claim 1 wherein the first segment has a segment speed state and the color of a road segment on a digital map display corresponds to the segment speed state.

32. A method of broadcasting a digital traffic map as in claim 1 wherein the first segment has a segment speed state and the shade of gray of a road segment on a digital map display corresponds to the segment speed state.

33. A method of broadcasting a digital traffic map as in claim 1 wherein the first segment has a segment speed state and a pattern of a road segment on a digital map display corresponds to the segment speed state.

34. A method of broadcasting a digital traffic map as in claim 1 wherein the first segment has a segment speed state and a user selects one of a table of different colors, an alternate table of different colors, a table of different shades of gray, or a table of different patterns to correspond to speeds on a digital map display.

35. A method of receiving a digital traffic map comprising:
receiving from a transmitter a first road segment having a first segment first endpoint and a first segment second endpoint, and
receiving from a transmitter a second road segment having a second segment first endpoint and a second segment second endpoint wherein the first segment and the second segment are combined together to form a portion of the digital map.
